(19) United States
(12) Patent Application Publication
(10) Pub. No.: US 2022/0076251 A1
(43) Pub. Date: Mar. 10, 2022

(54) PAYMENT CARD ENABLED DISTRIBUTED DIGITAL LEDGER SYSTEM TO HANDLE SECURITY OF BOTH CRYPTO AND NON-CRYPTO TRANSACTIONS

(71) Applicant: Joseph D. Hughes, Winter Garden, FL (US)

(72) Inventor: Joseph D. Hughes, Winter Garden, FL (US)

(21) Appl. No.: 17/469,864

(22) Filed: Sep. 8, 2021

Related U.S. Application Data
(60) Provisional application No. 63/075,308, filed on Sep. 8, 2020.

(51) Int. Cl. G06Q 20/38; G06Q 20/34; G06Q 20/36; G06Q 20/40; G06F 16/27

(52) U.S. Cl. CPC G06Q 20/389; G06Q 20/341; G06Q 20/3678; G06Q 20/3563; G06Q 20/326; G06Q 20/40145; G06Q 20/4016; G06Q 20/4015; G06F 16/27; G06Q 20/3674

(57) ABSTRACT

A method includes implementing a distributed digital ledger through a crypto-transactional platform, processing, via the crypto-transactional platform, a first crypto transaction through a payment card, and additionally processing, via the crypto-transactional platform, a second non-crypto transaction through the payment card. The distributed digital ledger is a growing set of records linked through cryptography. As part of processing the first crypto transaction and the second non-crypto transaction through the payment card via the crypto-transactional platform, the method also includes handling security of both the first crypto transaction and the second non-crypto transaction through the payment card via the distributed digital ledger.

### CLAIM OF PRIORITY

This Application is a conversion application of U.S. Provisional Patent Application No. 63/075,308 titled PAYMENT CARD UTILIZING A CRYPTOCURRENCY PLATFORM filed on Sep. 8, 2020. The contents of the aforementioned Provisional Application is incorporated herein by reference in entirety thereof.

### FIELD OF TECHNOLOGY

This disclosure relates generally to crypto-transactional platforms and, more particularly, to a payment card enabled distributed digital ledger system to handle security of both crypto and non-crypto transactions.

### BACKGROUND

Cryptocurrency exchanges may suffer from a number of issues. A payment card (e.g., a credit card, a debit card) issuer and the exchange ecosystem associated therewith may be inundated with both institutional and retail focused platforms that rush to the market leaving aside key exchange aspects. The crypto-industry may be facing a global crisis in the form of fraudulent transactions that negatively impact profitability and transaction viability. Payment card users may be victims of not only fraud, but also identity theft despite advances in encryption and card protection.

Financial institutions, cryptocurrency organizations and merchants are desperately searching for effective solutions to reduce and eliminate transaction fraud, Present day solutions, such as Verified by Visa®, chip, PINs, and CVV Codes, have not significantly reduced payment card fraud.

Also, many banks, card providers and/or financial institutions may be providing cryptocurrency based products to customers thereof. The customers may find it difficult to adopt these new products because of the tedium involved in setups and technology inertia.

### SUMMARY

Disclosed are a method, a device and/or a platform of a payment card enabled distributed digital ledger system to handle security of both crypto and non-crypto transactions.

In one aspect, a method includes implementing a distributed digital ledger through a crypto-transactional platform, processing, via the crypto-transactional platform, a first crypto transaction through a payment card, and additionally processing, via the crypto-transactional platform, a second non-crypto transaction through the payment card. The distributed digital ledger is a growing set of records linked through cryptography. As part of processing the first crypto transaction and the second non-crypto transaction through the payment card via the crypto-transactional platform, the method also includes handling security of both the first crypto transaction and the second non-crypto transaction through the payment card via the distributed digital ledger.

In another aspect, a crypto-transactional platform includes a payment card through which a first crypto transaction and a second non-crypto transaction via the crypto-transactional platform are conducted, and a set of networked servers implementing a distributed digital ledger. The distributed digital ledger is a growing set of records linked through cryptography. The crypto-transactional platform processes the first crypto transaction and the second non-crypto transaction through the payment card in accordance with handling security of both the first crypto transaction and the second non-crypto transaction through the payment card via the distributed digital ledger.

In yet another aspect, a crypto-transactional platform includes a payment card through which a first crypto transaction and a second non-crypto transaction via the crypto-transactional platform are conducted, and a set of networked servers implementing a distributed digital ledger. The distributed digital ledger is a growing set of records linked through cryptography. The crypto-transactional platform processes the first crypto transaction and the second non-crypto transaction through the payment card in accordance with handling security of both the first crypto transaction and the second non-crypto transaction through the payment card via the distributed digital ledger. The crypto-transactional platform further secures a digital wallet of a user of the payment card and the payment card using in-built bio-authentication available on a data processing device of the user of the payment card.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a manufacturing process of a payment card, according to one or more embodiments.

FIG. 2 is a schematic view of a data processing system for processing transactions associated with the payment card of FIG. 1, according to one or more embodiments.

FIG. 3 is a schematic view of a digital version of the payment card of FIG. 1 utilized for payments through example payment services via a mobile phone of a user thereof, according to one or more embodiments.

FIG. 4 is a schematic view of the mobile phone of the user of FIG. 3 executing a wallet application thereon.

FIG. 5 is a schematic view of primary systems of the computing platform of FIG. 2, according to one or more embodiments.

FIG. 6 is a schematic view of the data processing system of FIG. 2 in which security pertinent to both crypto transactions and non-crypto transactions associated with an account of the user of the payment card of FIGS. 1-4 is handled through a distributed digital ledger of FIG. 2, according to one or more embodiments.

FIG. 7 is a process flow diagram detailing the operations involved in a payment card enabled distributed digital ledger system to handle security of both crypto and non-crypto transactions, according to one or more embodiments.

Other features of the present embodiments will be apparent from the accompanying drawings and from the detailed description that follows.

### DETAILED DESCRIPTION

Example embodiments, as described below, may be used to provide a payment card enabled distributed digital ledger system to handle security of both crypto and non-crypto transactions. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

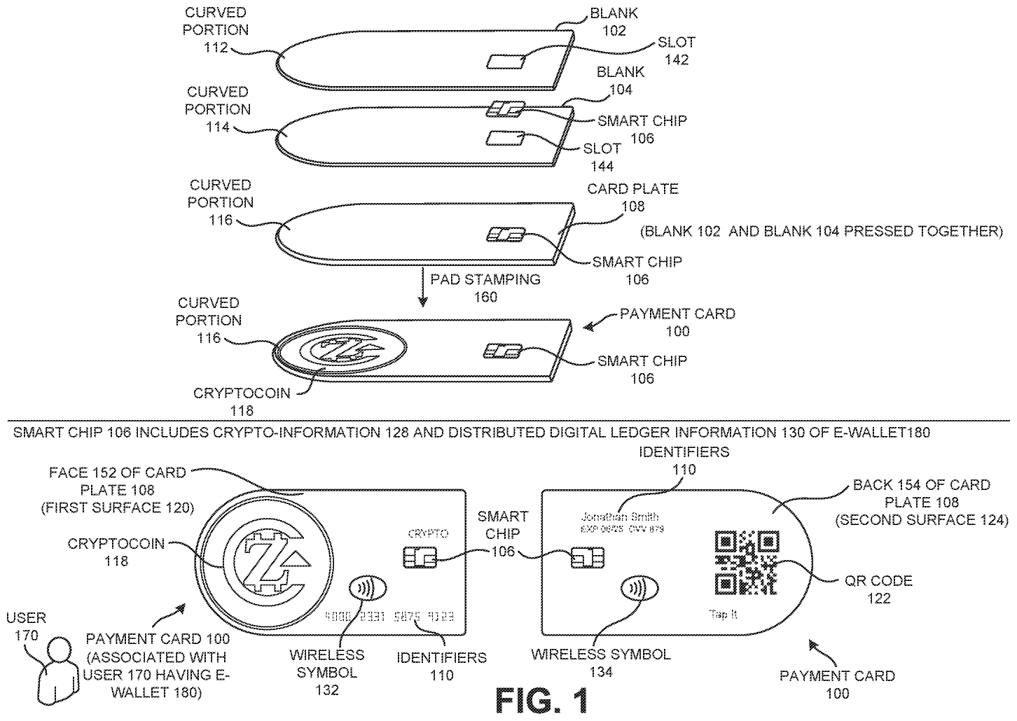

FIG. 1 shows a manufacturing process of a payment card 100 (e.g., a credit card, a debit card, a cryptocurrency/cryptotoken card), according to one or more embodiments. In one or more embodiments, blanks (e.g., blank 102 and blank 104) may be die cut from thin sheets of metal pre-coated with a matte black etched ceramic. “Blank,” as used herein, may indicate a substrate. In one or more embodiments, a smart chip 106 may be placed (e.g., inserted) between blank 102 and blank 104, which then are pressed together with a high bond adhesive. For the aforementioned purpose, blank 102 and blank 104 may each include a slot (e.g., slot 142 and slot 144 respectively) corresponding to smart chip 106 such that upon appropriate placement of smart chip 106 to correspond to slot 142 and slot 144 and subsequent pressing together of blank 102 and blank 104, smart chip 106 may nestle comfortably within slot 142 and slot 144.

It should be noted that in FIG. 1, slot 142 and slot 144 are shown as holes through blank 102 and blank 104 respectively merely for example purposes. In another example implementation, slot 142 or slot 144 alone may be a hole and the other slot 142 or slot 144 may either be absent or merely be a surface indentation on the corresponding blank 102 or blank 104. In one or more embodiments, the bonded blanks (e.g., blank 102 and blank 104) and the nestled smart chip 106 may realize a card plate 108 that is then put into, for example, a 110-ton press. In one or more embodiments, identifiers 110 (e.g., identifying numbers) may then be applied to a face 152 (e.g., an exposed surface of blank 102) and a back 154 (e.g., an exposed surface of blank 104) of card plate 108. In one or more embodiments, identifiers 110 may include but are not limited to a card number of payment card 100, an expiry date of payment card 100, a user name associated with payment card 100 and a Card Verification Value (CVV) associated with payment card 100.

In one or more embodiments, as shown in FIG. 1, blank 102 and blank 104 may each have a curved portion (e.g., curved portion 112 and curved portion 114 respectively; said curved portion 112 and curved portion 114 may form a single curved portion 116 of card plate 108) thereon; for e.g., curved portion 112 and curved portion 114 may be semicircular and may have a diameter of the semicircular portions along widths thereof. In other words, blank 102 and blank 104 may each have an end thereof curved into a curved portion, which is curved portion 112 of blank 102 and curved portion 114 of blank 104. Upon being pressed together with smart chip 106, curved portion 112 and curved portion 114 may form curved portion 116 of card plate 108. Other shapes such as ovals of curved portion 116, curved portion 112 and curved portion 114 are within the scope of the exemplary embodiments discussed herein.

In one or more embodiments, card plate 108 may be put through a pad stamping process (e.g., pad stamping 160) to apply a full scratchproof color (or, non-color) image of a cryptocurrency coin (cryptocoin) or a cryptotoken (FIG. 1 shows a cryptocoin 118 for example purposes) in/on a region of curved portion 116 thereof; said region may be on a first surface 120/face 152 of card plate 108. In one or more embodiments, security marks, names and numbers (e.g., identifiers 110 discussed above) to be shown on payment card 100 made from card plate 108 may also be engraved (e.g., through laser means). Further, in one or more embodiments, a security QR code 122 may be etched deep into/onto a second surface 124/back 154 of card plate 108/payment card 100 exactly below cryptocoin 118 for added security and functionality.

Cryptocoin 118, as discussed herein, may represent a digital currency or a token to be utilized as a medium of exchange of goods, services and/or other currencies/tokens; a ledger associated with transactions related to cryptocoin 118 may be part of a database with enhanced cryptographic security. Cryptocurrencies and tokens are known to one skilled in the art. Detailed description thereof has, therefore, been skipped for the sake of clarity and brevity. In one or more embodiments, cryptocoin 118, in itself, may represent actual value of a specific cryptocurrency/cryptotoken or may merely have a symbolic presence on payment card 100. In some embodiments, cryptocoin 118 may be backed up by a fiat currency, a commodity (e.g., gold, silver), a cryptocurrency or a combination thereof. In some other embodiments, cryptocoin 118 may be unbacked.

In one or more embodiments, payment card 100 may include smart chip 106 (e.g., cutting across a thickness of payment card 100) to store crypto-information 128 of a user 170 (e.g., owner) of payment card 100 and a distributed digital ledger information 130 (e.g., a hashgraph) of a digital wallet (e.g., e-wallet 180) thereof; the storage may aid information retrieval on behalf/part of the owner of payment card 100 after programming and signup. In one or more embodiments, payment card 100 may be provided with a capability to add e-wallet 180 to any smartphone compatible device such as an Android™ based smart device or an Apple® iPhone® and attach e-wallet 180 using an application (e.g., a mobile wallet application; to be discussed below) to an Android Pay™ or an Apple Pay® checking account, a personal savings account, a business account and the like to enable instant movement of funds from payment card 100 to cryptocurrency accounts (crypto-account) via, say, an online market exchange and dashboard.

Exemplary embodiments discussed herein provide the first instance of a traditional digital banking/financial account being coupled with a crypto-account (e.g., by way of payment card 100). Accordingly, the manufacturing process of payment card 100 may specifically be tailored to accommodate cryptocoin 118 or analogous crypto-element within payment card 100. Referring back to FIG. 1, in one or more embodiments, payment card 100 may show a wireless symbol (e.g., wireless symbol 132 and wireless symbol 134) on one or both of first surface 120 and second surface 124 thereof; this may imply that payment card 100 may be tapped on an appropriate reader instead of insertion thereof into another reader. In one example implementation, wireless symbol 132 and wireless symbol 134 may indicate a Radio Frequency Identification (RFID) chip (not shown) embedded within payment card 100. The aforementioned RFID chip may indicate contactless reading of payment card 100 while smart chip 106 may indicate contact based reading. FIG. 1 shows wireless symbols on both first surface 120 and second surface 124 merely for example purposes.

It should be noted that elements of payment card 100 discussed with reference to FIG. 1 are merely for illustrative purposes. Variations in elements, locations of the elements, layout of the elements, manufacturing processes and/or implementations thereof are within the scope of the exemplary embodiments discussed herein. In one example implementation, dimensions of payment card 100 may include a length of 101.0412 mm, a breadth/width of 54.0258 mm and a thickness of 1.5 mm. Obviously, variations therein are within the scope of the exemplary embodiments discussed herein.

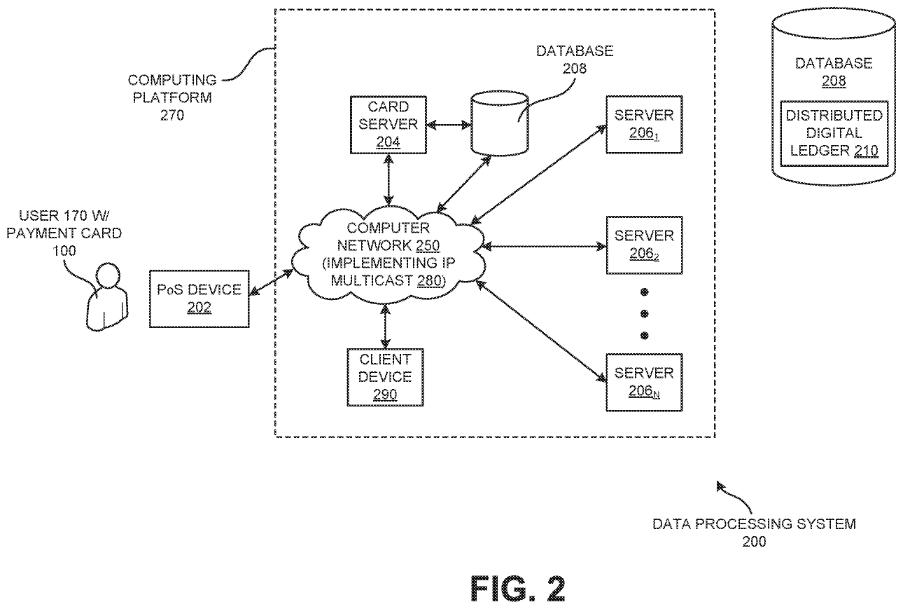

In one or more embodiments, hardware/software systems and/or payment solution(s) associated with payment card 100 may solve debit/credit card fraud using mobile bio-authentication and virtualization that runs entirely on a distributed digital ledger system (e.g., a blockchain, a hashgraph). In one or more embodiments, the aforementioned solutions may meet the needs of the security challenged currency transaction processing industry utilizing bio-authentication. FIG. 2 shows a data processing system 200 for processing transactions associated with payment card 100, according to one or more embodiments. In one or more embodiments, data processing system 200 may include a Point of Sale (PoS) device 202 to read details of user 170 of payment card 100 for initiating the payment process.

In one or more embodiments, PoS device 202 may be communicatively coupled (e.g., through a computer network 250 (e.g., including short and/or long range networks such as, but not limited to, a Wide Area Network (WAN), a Local Area Network (LAN), a Bluetooth® based network, a WiFi® based network and so on)) to a card server 204 (e.g., a merchant server; in one embodiment, a same entity as the issuer of payment card 100). In one or more embodiments, data processing system 200 may also include a number of other servers 206_{1-N} associated with a financial institution, a card company (e.g., the same/a different company associated with payment card 100), a clearinghouse, a distributed digital ledger (e.g., a blockchain) server and so on communicatively coupled to one another and card server 204 through computer network 250.

In one or more embodiments, one or more server(s) (e.g., card server 204 and/or one or more of servers 206_{1-N}) may be associated with a database 208 including a distributed digital ledger 210 (e.g., a blockchain and/or a hashgraph). In one or more embodiments, distributed digital ledger 210 (e.g., blockchain, hashgraph) may be a continually growing set of linked records; cryptography may provide the linkage. In one or more embodiments, distributed digital ledger 210 may serve as a public ledger of transactions associated with payment card 100. In one or more embodiments, payment card 100 may not only hold information (e.g., distributed digital ledger information 130) pertinent to distributed digital ledger 210 but also may integrate attributes therein such that the aforementioned information may only be read by distributed digital ledger 210 and/or by a merchant/merchant server (an example server 206_{1-N}) serving as a key master; the merchant may be associated with PoS device 202, card server 204 and/or one or more other servers 206_{1-N}.

In one or more embodiments, every payment card 100 may be provided with an encrypted digital wallet hexadecimal code that is 100% secure and may be added to any smart device (e.g., a smartphone) in a wallet application, Google Pay™, Google® wallet, Android Pay™, Apple Pay® or Apple Passbook®, for example, but, unlike many cards, the encryption (hash) cannot be read, stolen or cloned; anyone attempting to do so would get an endless, useless string of nonsense. Payment card 100 may, therefore, serve as a digital payment card through a smart device.

With respect to the network architecture implemented through data processing system 200, Internet Protocol (IP) multicast (e.g., IP multicast 280) may provide a dramatic increase in network efficiency because of mediation occurring at a hardware layer of computer network 250; selective broadcast to a dynamically specified group of nodes (e.g., servers discussed above, gateways, other elements) on computer network 250 may be enabled, which is ideal for a cryptocurrency consensus protocol implementation. Further, modern networking equipments may support IP multicast. In one or more embodiments, updating exchange nodes (e.g., servers discussed above, gateways, other elements) in computer network 250 to use IP multicast instead of less efficient application layer protocols used for processing other cryptocurrency transactions may dramatically reduce a bandwidth required by the exchange nodes for processing cryptocurrency transactions and other transactions pertinent to direct use of payment card 100 and/or associated indirect use thereof.

Multicast may consume approximately 1/M of the bandwidth compared to M separate unicast clients. For example, if a 1000 network nodes are communicating with one another, IP multicast may require only one-thousandth of the bandwidth that typical unicast communications would require.

In one or more embodiments, user 170 may be provided with the ability to upgrade payment card 100 thereof to utilize an application (e.g., a mobile application) on a smart data processing device (e.g., a mobile phone/smartphone) thereof. In one or more embodiments, payment card 100 may be a completely bio-authenticated, hexadecimal debit card that is secured without any requirements of pre-qualification by a financial institution (e.g., bank); this may be because each user (e.g., user 170) of a corresponding payment card 100 may serve as his/her own personal bank All technologies required for transaction and relevant processing through data processing system 200 may be linked to a secured backend database (e.g., database 208) that utilizes proprietary algorithms (e.g., cryptographic security algorithms).

In one or more embodiments, payment card 100 may be a first of a kind smart credit/debit card with closed debit payments integrated in digital form into smart data processing devices (e.g., smartphones) using a proprietary mobile application and other applications (e.g., based on Android Pay™, Apple Pay®). In one or more embodiments, payment card 100 may also integrate into a mobile phone's own bio-identification feature to authenticate user 170 as well as future expandable modules for financial transparency and/or access to funds held on distributed digital ledger 210.

In one or more embodiments, data processing system 200 and/or payment card 100 may provide a comprehensive solution for electronic transactional services by combining powerful and robust technologies with a cloud-based financial management system. Working together, in one or more embodiments, these technologies may solve all pressing financial security problems associated with international banking, commodity purchasing, everyday purchases globally, and commodity trading.

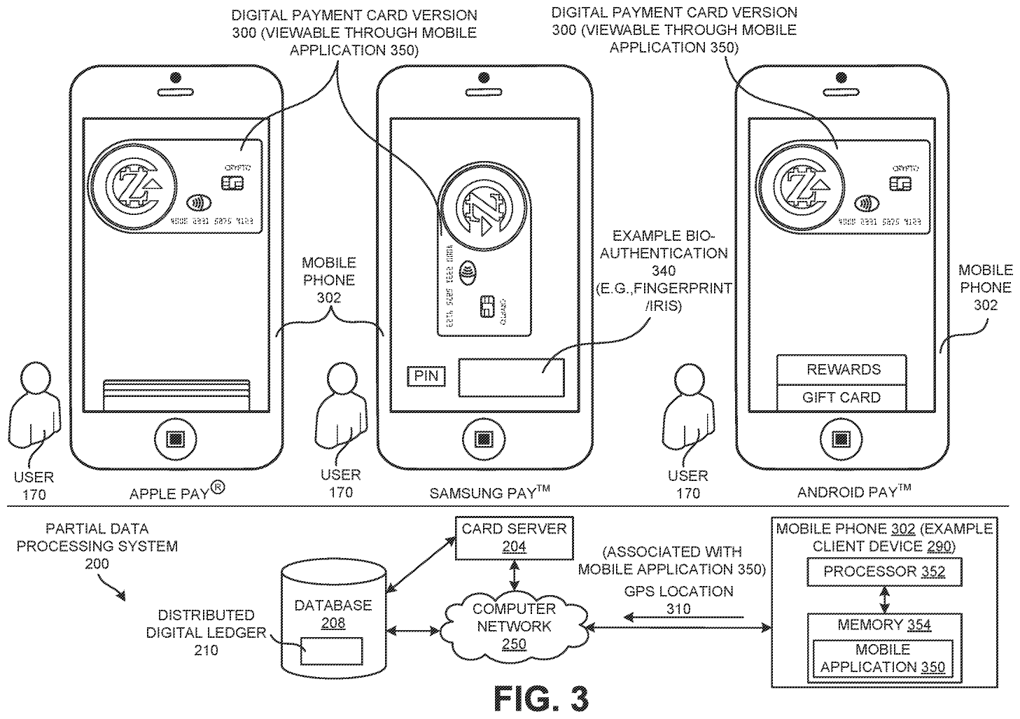

FIG. 3 shows a digital version (e.g., digital payment card version 300) of payment card 100 utilized for payments through example payment services via a mobile phone 302 of user 170. Example payment services shown in FIG. 3 such as Apple Pay®, Samsung Pay® and Android Pay™ should not be considered limiting. It should be noted that the card entity (e.g., card company, card issuing financial institution) associated with payment card 100 may offer rewards (e.g., cashbacks, bonus points, account credits) that can be utilized and/or controlled through the mobile application (e.g., mobile application 350 shown in FIG. 3) associated with payment card 100 and/or the other third-party payment services. Mobile application 350 may be the application that enables viewing of digital payment card version 300 through mobile phone 302; FIG. 3 additionally shows mobile phone 302 as including a processor 352 communicatively coupled to a memory 354, in which mobile application 350 is shown as being stored; mobile application 350 may execute through processor 352.

In one or more embodiments, incorporation of bio-authentication (e.g., bio-authentication 340 such as fingerprint/iris shown in FIG. 3) discussed above may utilize mobile devices (e.g., mobile phone 302) of end users (e.g., user 170) and a variety of secure identification methods such as unique hash codes, proprietary random number matching and/or biometrics (such as fingerprint/iris authentication; see FIG. 3, for example) through already proven and provided scanning technologies in said mobile devices.

Referring back to FIG. 2, data processing system 200 may include a client device 290 communicatively coupled to card server 204 and servers 206_{1-N} through computer network 250, according to one or more embodiments. An example client device 290 may be mobile phone 302 of user 170. In one or more embodiments, any attempted fraud with respect to a transaction on behalf of user 170 may result in an immediate notification being pushed to user 170 (e.g., through a text message to mobile phone 302) via a message requesting authorization of the transaction effected through data processing system 200/exchange. In one or more embodiments, theft of mobile phone 302 of user 170 and/or payment card 100 may not cause security threat(s) because of the encrypted digital wallet hexadecimal code/user secure identifier (e.g., based on hashgraph) implementation. In one or more embodiments, software implementation(s)/service(s) (e.g., through one or more servers (e.g., servers 206_{1-N} or card server 204) discussed with regard to FIG. 2) within data processing system 200 may leverage universal cellular Global Positioning System (GPS) location functionalities to isolate fraud and disable mobile application 350 for further use until successfully verified by user 170 (e.g., owner) on the backend of data processing system 200/exchange.

FIG. 3 shows GPS location 310 (or, a locational identifier in general) associated with mobile application 350 (and/or mobile phone 302) being leveraged by card server 204 (other servers 206_{1-N} leveraging GPS location 310 are within the scope of the exemplary embodiments discussed herein) having access to database 208, according to one or more embodiments. In one or more embodiments, as seen above, database 208 with distributed digital ledger 210 may handle all security operations relevant to both traditional banking/financial transactions and crypto-transactions using payment card 100. In one or more embodiments, data processing system 200 (e.g., through card server 204) may enable the abovementioned disabling of mobile application 350 pending further verification based on determining that GPS location 310 is different from that of a frequent location of user 170 or that of a registered location (e.g., city, country) thereof.

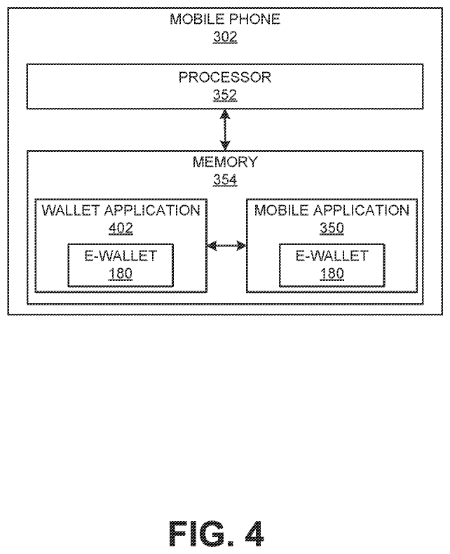

FIG. 4 shows mobile phone 302 executing a wallet application 402 (e.g., proprietary, third-party) thereon; wallet application 402 may enable registration of e-wallet 180 discussed above with respect to user 170. In one or more embodiments, wallet application 402 may enable configuring of payment card 100 for use digitally. In some embodiments, wallet application 402 may be the same as mobile application 350 (e.g., the same entity may provide both wallet application 402 and mobile application 350) and in some other embodiments, wallet application 402 and mobile application 350 may be different. FIG. 4 shows wallet application 402 and mobile application 350 as distinct from one another and both as stored in memory 354; both may execute through processor 352. In one or more embodiments, a physical version of payment card 100 may be used for in-person shopping transactions and digital payment card version 300 for both in-person and remote commercial/shopping transactions. In one or more embodiments, data processing system 200 may utilize a Transmission Control Protocol (TCP) for a data-intensive bootstrapping process when a guardian node (or, “full node”; server 206_{1-N}, card server 204, client device 290) connects to computer network 250 for the first time and needs to download the complete distributed digital ledger 210.

In one or more embodiments, for all other operations involving computer network 250, a User Datagram Protocol (UDP) may be used, in conjunction with Universal Plug and Play (UPnP) and UDP hole-punching for Network Address Translation (NAT) traversal. This may provide an optimal balance between network speed and reliability in the exchange/data processing system 200 implementation.

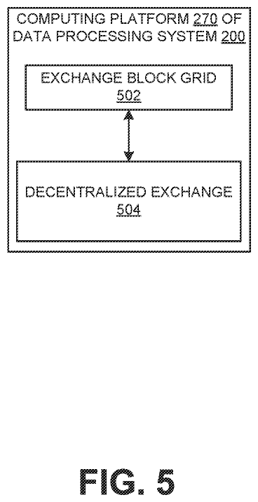

Referring back to FIG. 2, a computing platform 270 (e.g., an exchange platform) associated with data processing system 200 may include two primary systems (e.g., implemented through servers 206_{1-N}, card server 204). FIG. 5 shows the aforementioned primary systems, according to one or more embodiments. In one or more embodiments, computing platform 270 may include an exchange block grid 502 and a decentralized exchange 504. It should be noted that computing platform 270 may encompass all current and future systems that are built to process and/or facilitate transactions associated with cryptocurrencies (e.g., cryptocoin 118) and cryptotokens. It should be noted that the cryptocurrency denoted by cryptocoin 118 may not be a proprietary currency alone; all forms of cryptocurrencies and cryptotokens are within the scope of the exemplary embodiments discussed herein.

In one or more embodiments, the cryptocurrency represented by cryptocoin 118 may be a dynamic proof-of-commitment (DPOC) cryptocurrency. In one or more embodiments, the cryptocurrency may include the following features:

a) cryptographic digital signatures to prevent fraudulent transactions.

b) anonymity and privacy by default based on homomorphic encryption.

c) cryptographic hash function and multi-hop locks based on ED25519 elliptic-curve public key encryption.

d) automated stakeholder node voting to achieve consensus-based transaction verification.

e) Vote delegation to ensure voting quorums, which ensures broad-based transaction consensus and broad-based democratic human consensus on major ecosystem governance issues.

f) Hybrid Directed Acyclic Graph (DAG)/blockchain database structure (“Block Grid”) to connect all transaction blocks (e.g., of distributed digital ledger 210) in a linear, immutable historical chain, which achieves a unique combination of ledger integrity, high speed, and throughput.

g) Block Grid (e.g., exchange block grid 502) to provide public ledger integrity that is computationally efficient to verify back to the exchange genesis block.

h) built-in auditing mechanisms that protect user privacy and allow user-authorized auditors and user-authorized government authorities to audit transactions as required by each country's applicable laws.

i) a database structure that enables easy implementation of aggressive pruning, and snapshotting; these features may ensure long-run scalability, meaningful decentralization, and high speed and throughput.

j) exceptionally strong and inherent resistance to “double-spend attacks,” “51% attacks,” “Distributed Denial-of-Service (DDOS) attacks,” and “Sybil attacks,” among others, which provides strong assurance of public ledger integrity.

k) broadly attractive economic incentive structures carefully designed to create the most stable, equitable, sustainable, and user-friendly ecosystem humanly possible.

In one or more embodiments, financial settlements through data processing system 200 may be extremely secure as transactions through computing platform 270 are captured in distributed digital ledger 210, which is hack proof. In one or more embodiments, data processing system 200 may provide all the tools needed to take the financial sector into the future, where massive amounts of lost revenue from fraud and cyber-crime can be recovered, monitored and/or stopped.

Exemplary embodiments discussed above may provide for a lot of advantages including but not limited to:

1) No need for carrying large funds and cash in user (e.g., user 170) pockets.

2) Mobile transfer of crypto-coins (e.g., cryptocoin 118) to get money converted to user wallets (e.g., e-wallet 180).

3) Private and secure transactions; extremely low transaction fees.

4) Decreased fraud and private, secure transactions.

5) Push notifications and/or e-mails regarding transactions made.

6) Anonymity and private encryption with a hexadecimal hash-graph on distributed digital ledger 210 (e.g., a blockchain implementation).

7) Easy to use and implemented for vendors AND customers with no disruptions in routine.

8) No security risk to parties involved in transactions.

9) Counterfeiting eliminated completely.

10) Random Airdrops of cryptocoins (e.g., cryptocoin 118) into e-wallets (e.g., e-wallet 180) by notifying users (e.g., user 170) on mobile phones (e.g., mobile phone 302) thereof via push notifications.

In one or more embodiments, vendors may have a profit center and may cater to users of payment card 100/cryptocurrencies/cryptotokens not currently being captured by transmitting a beacon on-site; said beacon may capture younger and/or international crypto-users. Low transaction fees have been discussed above; it should be noted that data processing system 200 may enable sharing of transaction fees with users (e.g., users having premium subscriptions). In one or more embodiments, transaction processing discussed above may involve no charge backs and may provide for easy money conversion from one currency (e.g., USD) to a number of/all international fiat currencies. In addition, based on a Federal Communications Commission (FCC) code included on every mobile phone, in-motion identification (IMID) may be possible.

In one or more embodiments, database 208 may record transactions of each purchased item including taxation in distributed digital ledger 210. In one or more embodiments, payment card 100/digital payment card version 300 may require no changes in current PoS machines including no reprogramming and incurring no hardware costs. However, it should be noted that proprietary PoS devices having the capability to uniquely read payment card 100/digital payment card version 300 are within the scope of the exemplary embodiments discussed herein.

In one or more embodiments, setting up a digital wallet (e.g., e-wallet 180) may be done within milliseconds via secured, integrated payment gateways upon sign up that are part of data processing system 200. In one example implementation, each new sign up may be required to purchase at least $15 in cryptocoin 118/cryptocurrency/cryptotoken(s). Every purchase may be verified with an individual key; for example, an account number private key (e.g., ZC37sge271358rdkg637) may be converted to a 128 hexadecimal (e.g., a hashgraph) masked routing number more commonly called an e-wallet (e.g., e-wallet 180) used for instant deposit into an account of user 170 specified on a dashboard. Digital payment card version 300 may then be downloaded into a mobile device (e.g., mobile phone 302) of user 170.

Once the download is complete, digital payment card version 300 may be added to third-party payment applications using built-in bio-authentication available on most mobile phones (e.g., mobile phone 302) to secure e-wallet 180. Distributed digital ledger 210 may complete validation and digital payment card version 300 may be ready for commercial transactions with entities anywhere in the world including places where cryptocurrencies are illegal.

Exemplary embodiments may provide the very first crypto-based credit/debit card (e.g., payment card 302) that also integrates into in-built bio-authentication capabilities of a smartphone (e.g., mobile phone 302) via a digital wallet (e.g., e-wallet 180); this may be a hybrid function enabling anyone with the smartphone (e.g., Apple® or Android™ based) to automatically transfer any currency to any casino machine anywhere in the world. Through push notification(s) and/or location based services such as geofencing, users may be integrated into a crypto-currency/token/coin (e.g., an airdrop system) exchange platform to give casinos a significant edge over local competitors by boosting attendance and capturing lost passersby (e.g., using geofencing).

An example scenario of signing up may involve a guest coming to a desk to purchase with money or credit/debit card. The desk may recommend signing up for a crypto-wallet (e.g., e-wallet 180); the sign-up process may be simple and instantaneous; the crypto-wallet may be loaded with the existing debit/credit card/payment card 100 to enable the guest to spend money therewith. If the guest already has a wallet and crypto-money on the wallet, the guest may simply proceed to shop; the guest (e.g., user 170 of mobile phone 302) may get within a few inches from a PoS machine and may pay for items with the crypto-wallet on the mobile phone just like a regular credit card (e.g., issued by Visa® or MasterCard®).

It should be noted that, as user identification may be provided through a number of secure means discussed above, exemplary embodiments relevant to payment card 100 may dispense with a need to provide a magnetic stripe therein to identify the user (e.g., user 170). As security and identification may be handled by distributed digital ledger 210, digital transactions including non-crypto (mainstream) transactions may both be processed through distributed digital ledger 210 instead of traditional avenues. Exemplary embodiments may combine the processing/security requirements of traditional digital transactions and cryptocurrency/cryptotoken transactions in distributed digital ledger 210. This way, the magnetic stripe discussed above and traditional processing/security may be bypassed. However, a combination of tradition and distributed digital ledger 210 may also be envisioned; a payment card 100 may still include a magnetic stripe in addition to other elements; all reasonable variations are within the scope of the exemplary embodiments discussed herein.

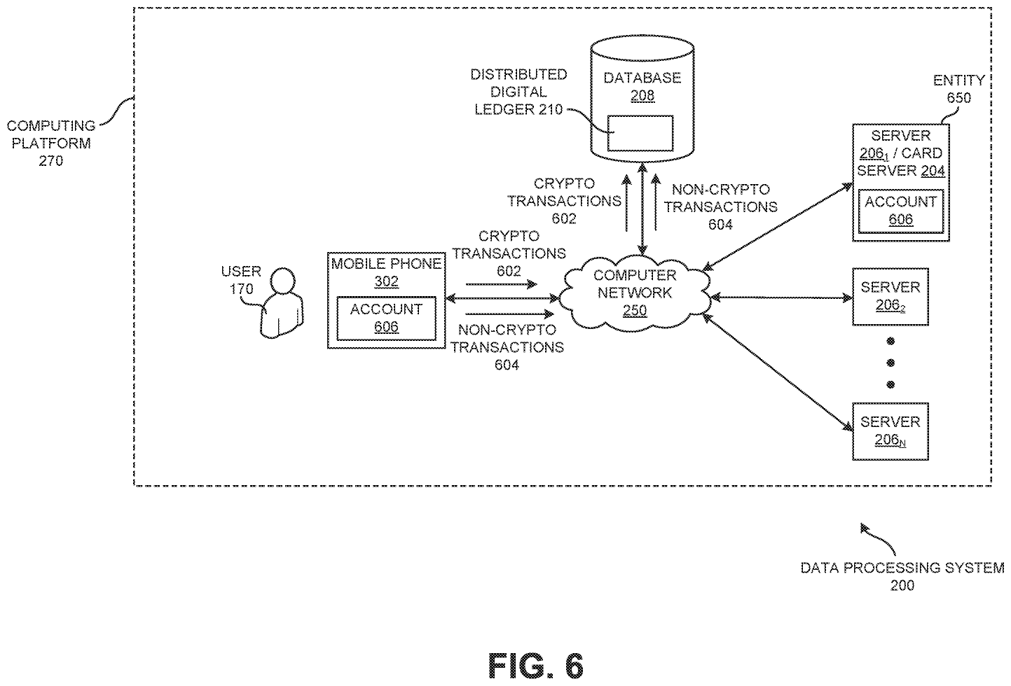

FIG. 6 shows data processing system 200 in which security pertinent to both crypto transactions 602 and non-crypto transactions 604 associated with an account 606 of user 170 at mobile phone 302 (example client device 290) may be handled through distributed digital ledger 210, according to one or more embodiments. In one or more embodiments, as discussed above, the aforementioned security may enable integration of in-built bio-authentication 340 capabilities available in mobile phone 302 therewith. In one or more embodiments, account 606 may be associated with an entity 650 corresponding to one or more server(s) (e.g., servers 206_{1-N}, card server 204); account 606 may also include one or more accounts (e.g., crypto, non-crypto) of user 170 with entity 650. In one or more embodiments, it may be possible to envision a non-account secure identifier based transaction security provided through distributed digital ledger 210. To summarize, exemplary embodiments discussed herein may provide for a payment card (e.g., payment card 100/digital payment card version 300) enabled distributed digital ledger system (e.g., data processing system 200 with distributed digital ledger 210) to handle security of both crypto (e.g., crypto transactions 602) and non-crypto transactions (e.g., non-crypto transactions 604). All reasonable variations are within the scope of the exemplary embodiments discussed herein.

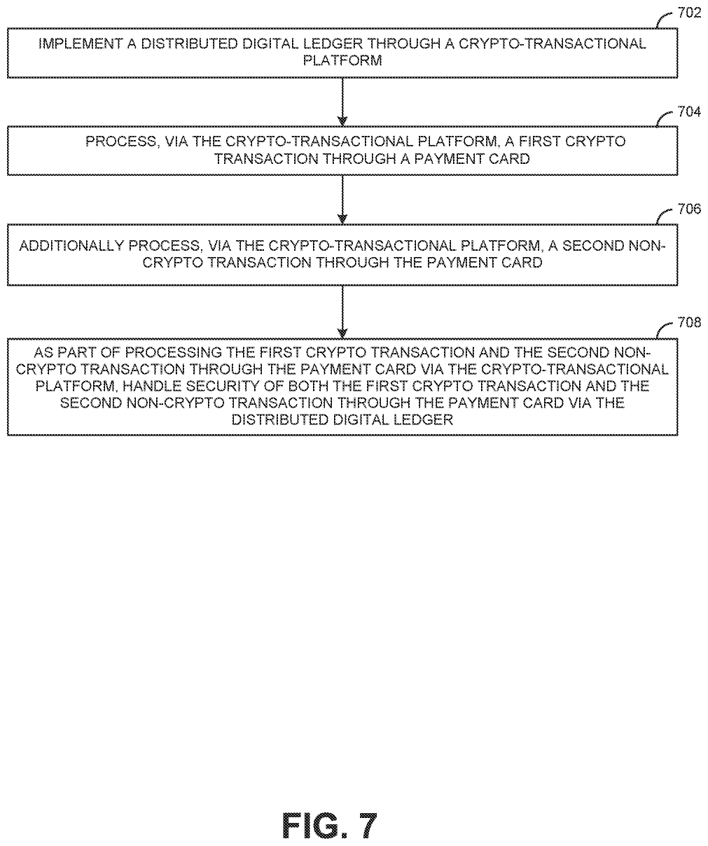

FIG. 7 shows a process flow diagram detailing the operations involved in a payment card (e.g., payment card 100) enabled distributed digital ledger system (e.g., data processing system 200, computing platform 270) to handle security of both crypto (e.g., crypto transactions 602) and non-crypto transactions (non-crypto transactions 604), according to one or more embodiments. In one or more embodiments, operation 702 may involve implementing a distributed digital ledger (e.g., distributed digital ledger 210) through a crypto-transactional platform (e.g., computing platform 270). In one or more embodiments, the distributed digital ledger may be a growing set of records linked through cryptography.

In one or more embodiments, operation 704 may involve processing, via the crypto-transactional platform, a first crypto transaction (e.g., crypto transaction 602) through a payment card (e.g., payment card 100). In one or more embodiments, operation 704 may involve additionally processing, via the crypto-transactional platform, a second non-crypto transaction (e.g., non-crypto transaction 604) through the payment card. In one or more embodiments, as part of processing the first crypto transaction and the second non-crypto transaction through the payment card via the crypto-transactional platform, operation 708 may then involve handling security of both the first crypto transaction and the second non-crypto transaction through the payment card via the distributed digital ledger.

Although the present embodiments have been described with reference to specific example embodiments, it will be evident that various modifications and changes may be made to these embodiments without departing from the broader spirit and scope of the various embodiments. For example, each server (e.g., server 206_{1-N}, card server 204) discussed above may be a single server or a number of servers (e.g., a network/cluster of servers).

In addition, it will be appreciated that the various operations, processes, and methods disclosed herein may be embodied in a non-transitory machine-readable medium (e.g., a Compact Disc (CD), a Digital Video Disc (DVD), a hard drive) and/or a machine accessible medium compatible with a data processing system (e.g., a computing system such as data processing system 200), and may be performed in any order (e.g., including using means for achieving the various operations). Accordingly, the specification and drawings are to be regarded in an illustrative rather than a restrictive sense.

What is claimed is:

1. A method comprising:
implementing a distributed digital ledger through a crypto-transactional platform, the distributed digital ledger being a growing set of records linked through cryptography;
processing, via the crypto-transactional platform, a first crypto transaction through a payment card;
additionally processing, via the crypto-transactional platform, a second non-crypto transaction through the payment card; and
as part of processing the first crypto transaction and the second non-crypto transaction through the payment card via the crypto-transactional platform, handling security of both the first crypto transaction and the second non-crypto transaction through the payment card via the distributed digital ledger.

2. The method of claim 1, further comprising:
implementing the payment card with a smart chip;
storing, in the smart chip, crypto-information and distributed digital ledger information of a digital wallet of a user of the payment card; and
retrieving, through the crypto-transactional platform. information on behalf of the user of the payment card based on the storage.

3. The method of claim 1, further comprising:
providing a representation of at least one of: a cryptocurrency and a cryptotoken on the payment card; and
enabling the first crypto transaction through the payment card based on the at least one of: the cryptocurrency and the cryptotoken.

4. The method of claim 2, further comprising:
setting up, via the crypto-transactional platform, the digital wallet of the user of the payment card on a data processing device thereof; and
downloading, via the crypto-transactional platform, a digital version of the payment card into the data processing device of the user of the payment card following the setting up of the digital wallet.

5. The method of claim 4, further comprising enabling, through an application associated with the crypto-transactional platform and executing on the data processing device of the user of the payment card, viewing of the digital version of the payment card via the data processing device.

6. The method of claim 5, further comprising additionally securing the digital wallet and the payment card using in-built bio-authentication available on the data processing device.

7. The method of claim 5, further comprising isolating fraud associated with at least one of: the first crypto transaction and the second non-crypto transaction based on leveraging a locational identifier associated with the application.

8. A crypto-transactional platform comprising:
a payment card through which a first crypto transaction and a second non-crypto transaction via the crypto-transactional platform are conducted; and
a set of networked servers implementing a distributed digital ledger, the distributed digital ledger being a growing set of records linked through cryptography,
wherein the crypto-transactional platform processes the first crypto transaction and the second non-crypto transaction through the payment card in accordance with handling security of both the first crypto transaction and the second non-crypto transaction through the payment card via the distributed digital ledger.

9. The crypto-transactional platform of claim 8:
wherein the payment card further comprises a smart chip having crypto-information and distributed digital ledger information of a digital wallet of a user of the payment card stored therein, and
wherein the crypto-transactional platform retrieves information on behalf of the user of the payment card based on the storage.

10. The crypto-transactional platform of claim 8:
wherein the payment card further comprises a representation of at least one of: a cryptocurrency and a cryptotoken thereon, and
wherein the crypto-transactional platform enables the first crypto transaction through the payment card based on the at least one of: the cryptocurrency and the cryptotoken on the payment card.

11. The crypto-transactional platform of claim 9, wherein a digital version of the payment card is downloaded into a data processing device of the user of the payment card following set up of the digital wallet of the user of the payment card on the data processing device.

12. The crypto-transactional platform of claim 11, wherein the crypto-transactional platform enables viewing of the digital version of the payment card via the data processing device through an application executing on the data processing device of the user of the payment card.

13. The crypto-transactional platform of claim 12, wherein the crypto-transactional platform enables securing the digital wallet and the payment card using in-built bio-authentication available on the data processing device.

14. The crypto-transactional platform of claim 12, wherein the crypto-transactional platform isolates fraud associated with at least one of: the first crypto transaction and the second non-crypto transaction based on leveraging a locational identifier associated with the application.

15. A crypto-transactional platform comprising:
a payment card through which a first crypto transaction and a second non-crypto transaction via the crypto-transactional platform are conducted; and
a set of networked servers implementing a distributed digital ledger, the distributed digital ledger being a growing set of records linked through cryptography,
wherein the crypto-transactional platform processes the first crypto transaction and the second non-crypto transaction through the payment card in accordance with handling security of both the first crypto transaction and the second non-crypto transaction through the payment card via the distributed digital ledger, and
wherein the crypto-transactional platform further secures a digital wallet of a user of the payment card and the payment card using in-built bio-authentication available on a data processing device of the user of the payment card.

16. The crypto-transactional platform of claim 15:
wherein the payment card further comprises a smart chip having crypto-information and distributed digital ledger information of the digital wallet of the user of the payment card stored therein, and
wherein the crypto-transactional platform retrieves information on behalf of the user of the payment card based on the storage.

17. The crypto-transactional platform of claim 15:
wherein the payment card further comprises a representation of at least one of: a cryptocurrency and a cryptotoken thereon, and
where the crypto-transactional platform enables the first crypto transaction through the payment card based on the at least one of: the cryptocurrency and the cryptotoken on the payment card.

18. The crypto-transactional platform of claim 15, wherein a digital version of the payment card is downloaded into the data processing device of the user of the payment card following set up of the digital wallet of the user of the payment card on the data processing device.

19. The crypto-transactional platform of claim 18, wherein the crypto-transactional platform enables viewing of the digital version of the payment card via the data processing device through an application executing on the data processing device of the user of the payment card.

20. The crypto-transactional platform of claim 19, wherein the crypto-transactional platform isolates fraud associated with at least one of: the first crypto transaction and the second non-crypto transaction based on leveraging a locational identifier associated with the application.
